(19) United States
(12) Patent Application Publication
(10) Pub. No.: US 2010/0114751 A1
(43) Pub. Date: May 6, 2010

(54) METHOD FOR TRADING USING VOLUME SUBMISSIONS

(76) Inventors: Andrew Busby, Aurora, IL (US); William D. Cunningham, South Barrington, IL (US)

Correspondence Address: MCGUIREWOODS, LLP, 1750 TYSONS BLVD, SUITE 1800, MCLEAN, VA, 22102, US

(21) Appl. No.: 12/608,513

(22) Filed: Oct. 29, 2009

Related U.S. Application Data
(63) Continuation of application No. 11/331,819, filed on Jan. 13, 2006, now abandoned.

(51) Int. Cl. G06Q 40/00; G06F 3/00

(52) U.S. Cl. 705/37; 715/700

(57) ABSTRACT

A method for reducing the amount of time for a user to submit an order is provided. Volume submission allows a user to submit and revise orders with a single action on a volume entry region. Typically, a user has to set a price and quantity. Many users wait for specific prices or track prices dynamically based on predefined criteria. These trading styles eliminate the need to set the price manually for each transaction. It is advantageous to provide a list or menu of buttons or selections with preconfigured volumes for the user to choose, thus allowing the single action of choosing the volume to submit the order.

### FIELD OF THE INVENTION

The present invention relates to the field of futures trading. More particularly, the present invention relates to the use of a software application in order to trade futures over an exchange. Even more particularly, the present invention relates to the use of a software application to submit a volume submission trade over an exchange. However, it is to be appreciated that the present invention is amenable to other like applications.

### BACKGROUND OF THE INVENTION

In general, commodities have been traded in the same way for hundreds of years. The Chicago Board of Trade (“CBOT”) began trading commodities in the 1800's. Since the inception of the CBOT, many different exchanges all over the world exits and each trade commodities.

More recently, electronic commodities trading has been added to the exchanges. This has permitted vast accessibility to these exchanges without requiring that a user be present within the exchange and without the necessity of “paper trades.” Not only has the use of electronic trading greatly increased the ability for users to trade commodities, but has also increased the volatility of the exchanges, since there are more users that have easier and faster access to the exchanges.

Electronic trading of commodities is achieved through a combination of exchange hosts, Internet service providers (“ISPs”) and application service providers (“ASPs”). The exchange hosts are primarily responsible for order routing, price dissemination and connectivity, which includes not only bidirectional communication but also preserving redundancy.

The ASPs that are utilized in electronic commodities trading are responsible for, among other things, maintaining connectivity, hosts and clients. Connectivity is maintained with respect to exchange hosts through bidirectional communication with redundancy. The hosts are responsible for risk management throughout the trading day as well as the back office integration/imports. Hosts are also responsible for connectivity of the client session management, price dissemination and order routing.

The client is what the user interacts with directly. The client is responsible for connectivity through the Internet and through direct connection. The client includes a client session management feature which will monitor the connectivity of the client. Moreover, the client will typically include a configurable display that includes prices not only of the last trade, but also of the depth of market. The client also allows the user to manipulate orders, keep track of an order book and monitor account status, including balances, profit and loss and positions.

Each of the exchanges has requirements in order for the hosts and the clients to participate in the market. While the exchange interface is the same for all participants, the different ASPs and proprietary systems interfaces can and do differ. Trading tools such as described in the present invention optimize these differences in proprietary systems, allowing some systems to be more efficient than others. In developing proprietary systems, user error is minimized, total user actions are minimized and repeated actions are simplified or eliminated.

The following invention has been designed for the electronic commodities trading industry. The invention is intended to be incorporated into electronic trading tools. The key to executing or manipulating trades in an electronic market is speed. These inventions reduce the time it takes for a user to perform specific activities. The present invention thus improves the efficiency of user activities and adds value to an electronic trading system.

### SUMMARY OF THE INVENTION

In accordance with one aspect of the present invention an improved method for buying and selling over an exchange is provided. The method includes the step of first displaying on an electronic display a price region comprised of a plurality of different prices, a bidding lot region comprised of a plurality of bids for lots at a different prices, and an offering lot region comprised of a plurality of offers for lots at different prices. The method further comprises the step of updating said regions of said display to reflect real-time trading action of said exchange. The method further includes the step of providing a user input interface with the exchange which receives a user input in the form of a command for a desired number of lots, and a communication linkage which registers said input with the exchange. The method further includes the step of generating on said electronic display a graphical user lot input window which includes a plurality of predefined selections corresponding to different desired lot volumes. The method also includes the steps of linking an input to said lot input window to a predefined price and implementing a user lot input by a single click on a desired lot volume of said lot input window.

In yet another aspect of the present invention, a method for buying and selling over an exchange is provided wherein said trading action displayed includes an inside market that reflects a best offer and a best bid associated with a respective price, said graphical user lot input window including separate buy and sell areas each having a plurality of predefined selections corresponding to different desired lot volumes, said linkage having a default predefined price to be the then-existing best offer and best bid.

In still another embodiment of the present invention, a method for buying and selling over an exchange is provided wherein the user can select a price as said predefined price instead of said default predefined price.

In another embodiment of the present invention, a method for buying and selling over an exchange is provided wherein said plurality of predefined selections are at least three different desired lot volumes for each of said buy and sell areas.

In a further embodiment of the present invention, a method for buying and selling over an exchange is provided wherein said at least six different desired lot volumes are each separately variable by the user.

In yet another embodiment of the present invention, a method for buying and selling over an exchange is provided wherein said exchange is a commodity exchange.

In another embodiment of the present invention, a method for buying and selling over an exchange is provided wherein a desired price is displayed as a highlighted cell on a price grid consisting of a column of prices and an associated column of available bid quantities and an associated column of available offer quantities.

In a still further embodiment of the present invention, a method for buying and selling over an exchange is provided wherein said grid scrolls as said inside market changes, with said inside market moving relative to a center area of said electronic display.

In yet another embodiment of the present invention, a method for buying and selling over an exchange is provided wherein said inside market is maintained substantially centered on said price grid.

In still another embodiment of the present invention, a method for trading futures over an exchange is provided, where the futures correspond to contracts that have an inside market that reflects a best offer and a best bid for a particular contract, and includes the steps of displaying on an electronic display a price region for each contract; wherein each price region includes a best offer and a best bid associated with a respective prices;, displaying on an electronic display a user input interface separate from the price region for each contract; wherein said user input interface includes three or more predefined selections corresponding to a desired volume that is set to a predefined price and selecting one of the predefined selections within the user input interface to initialize a trade for futures.

### BRIEF DESCRIPTION OF THE DRAWINGS

FIG. 1 illustrates an exemplary embodiment of the present invention.

FIG. 2 illustrates another exemplary embodiment of the present invention.

FIG. 3 illustrates yet another exemplary embodiment of the present invention.

### DETAILED DESCRIPTION OF AN EMBODIMENT OF THE INVENTION

In accordance with one embodiment of the present invention, multiple volume buttons are utilized in order to allow the single click entry of a different quantity of buy or sell orders to join or hit the best bid or offer of a market.

Embodiments of the present invention include multiple volume buttons that can be found on a user input interface from within the software application for trading futures over an exchange. Multiple volume buttons preferable exist for each side of the market, e.g., buttons for submitting volumes of 1, 2, or even 10 lot buy orders and buttons for submitting volumes of 1, 2, or even 10 lot sell orders.

In one embodiment, a user clicks on a volume button in order to submit an order of quantity equal to that specified on the volume button and side of the market (i.e., buy or sell) at a pre-determined price. The pre-determined price is preferable selected by the user. One default pre-determined price would be the best bid or offer of the market at that time. Other examples would be if the user desired a certain price, and could set the volume buttons to purchase a pre-determined volume of futures at the desired price. The order type can also be pre-determined by the user. For example, within the buy order, the user can specify that the volume button is for a limit order. Alternatively, the order type that is pre-determined by the user can be of other types, for example, a StopMarket, StopLimit, MIT, etc. The same types of orders can also be predetermined for a sell order.

In embodiments of the present invention, the individual volume buttons are also configurable based on the user's preferences. Within the software application, the user has the ability to specify the volume that will be associated with each of the buttons and also how many volume buttons exist on the user input interface within the software application. For example, if a user only makes for different volumes of trades, one lot, five lots, ten lots and fifty lots, the user can specify that four buttons be listed on the user input interface within the software application and can specify those specific volumes of shares for each of the buttons. It is contemplated that many buttons can be specified within the user input interface, depending on the user's preferences.

Embodiments of the present invention also include a visual indicator showing the price that the order will be submitted at when a volume button is selected, or clicked, by the user. In one embodiment in accordance with the present invention, the visual indicator is preferably a highlighted cell on a grid consisting of a column of prices and associated available bid and offer quantities for a market. In other embodiments, the visual indicator is a highlighted cell on a smooth scrolling price grid consisting of a column of prices and associated available bid and offer quantities for a market. In yet other embodiments in accordance with the present invention, the visual indicator is a highlighted cell on an always centered price grid consisting of a column of prices and associated bid and offer quantities for a market.

In accordance with one embodiment of the present invention, the user can switch between auto-tracking being enabled or disabled. When auto-tracking is enabled, the highlighted prices are always pre-determined to correspond to the best bid and offer for the market, even as the best bid and offer changes through market activity. When auto-tracking is disabled, the user can specify the pre-determined highlighted prices. The user can select a price on the grid consisting of a column of prices and having associated available bid and offer quantities for a market. Alternatively, the user can select a price in a price number selector within the toolbars of the trading software application.

Once the user has selected whether auto-tracking will be enabled or disabled and then has selected a desired highlighted price, the user can select a volume button in order to initiate the trade over the exchange. Once the user has initiated the trade and the trade has been completed, the user's preference system may be configured so that auto-tracking is automatically re-enabled, changing the predetermined price to the current best bid or offer price.

In another embodiment, the volume buttons are in close proximity on the user interface to working orders. In this embodiment, the trading software application includes two grids, one for each side of the market and each displaying working orders for the current market and side, e.g., a grid of buy orders and a grid of sell orders. In one example, the orders are sorted by price so that the orders priced closest to the inside market are closest to the display of the inside market. Alternatively, the orders are sorted by price so that the orders priced closest to the market are closest to the center of the display and associated buy and sell multiple volume buttons. It is also contemplated by the present invention that both grids are sorted in descending price order.

In yet other embodiments in accordance with the present invention, the grids show individual order that is working, e.g., two separate one lot buy orders at a price of 11000 would show as two grid items each saying one lot working at a price of 11000. In addition, it is contemplated that it is possible to cancel a single order from the market by clicking on that order within the grid.

In yet other embodiments in accordance with the present invention, the grids shows a summary of all of the orders that are working at each different price and side, e.g., two separate one lot buy orders at a price of 11000 would show as a single grid item saying that two lots are working at a price of 11000. In this embodiment, it is contemplated that it is possible to cancel multiple orders, including those at the same price, from the market by clicking on the summary item within the grid.

In still other embodiments in accordance with the present invention, all of the user's working orders from one side of the market can be cancelled by clicking on a single button for that side of the market.

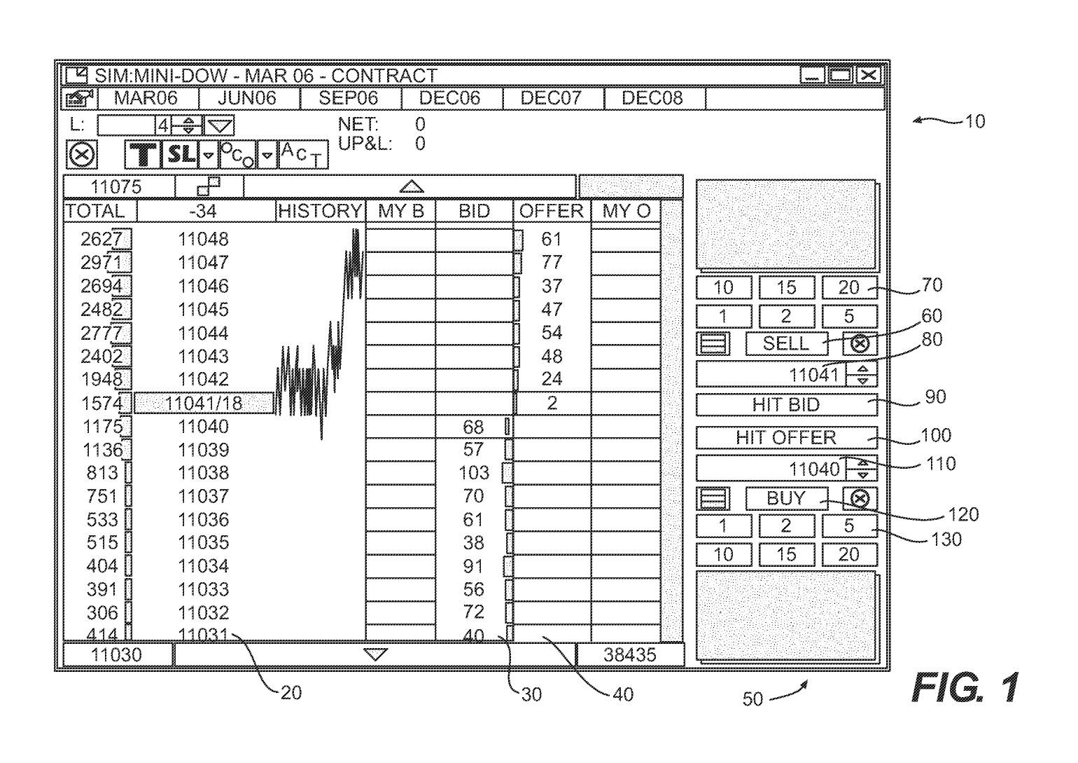

FIG. 1 is illustrative of one embodiment in accordance with the present invention, where a trading software application 10 is utilized for buying and selling over an exchange. The software application 10 displays a column of different prices 20, depending on the commodity that is selected. The column prices 20 of the commodity that is selected correspond to both a bid column 30 and an offer column 40 for each displayed price of the commodity. Each column of prices 20, bids 30 and offers 40 of the trading software 10 is updated on a display to reflect real-time trading action of the exchange.

The trading software 10 includes a user input interface 50 with the exchange which receives a user input in the form of a command for a desired number of lots of the particular commodity to be traded. The command for the desired number of, for example, sell 20 lots is identifiable by volume buttons 70, which include a communication linkage which registers the input from the volume buttons 70 with the exchange. The volume buttons 70 on the user input interface 50 for the sell portion, each include a predefined lot volume, as indicated by the numbers. Each of the volume buttons 70 is linked to a corresponding predefined price 80. A single click of a volume button 70 by the user initializes a trade of the desired lot volume.

Similarly, the buy 120 volume submission includes volume buttons 130 that correspond to a price 110 for an offer. The “Hit Offer” 100 is displayed by the price 110 of the current offer for the buy 120 side. The current offer, as explained above, is pre-determined by the user. In one embodiment, the current offer is set to be the current best offer on the market. In another embodiment, the user can set the desired current offer to a price that is fixed.

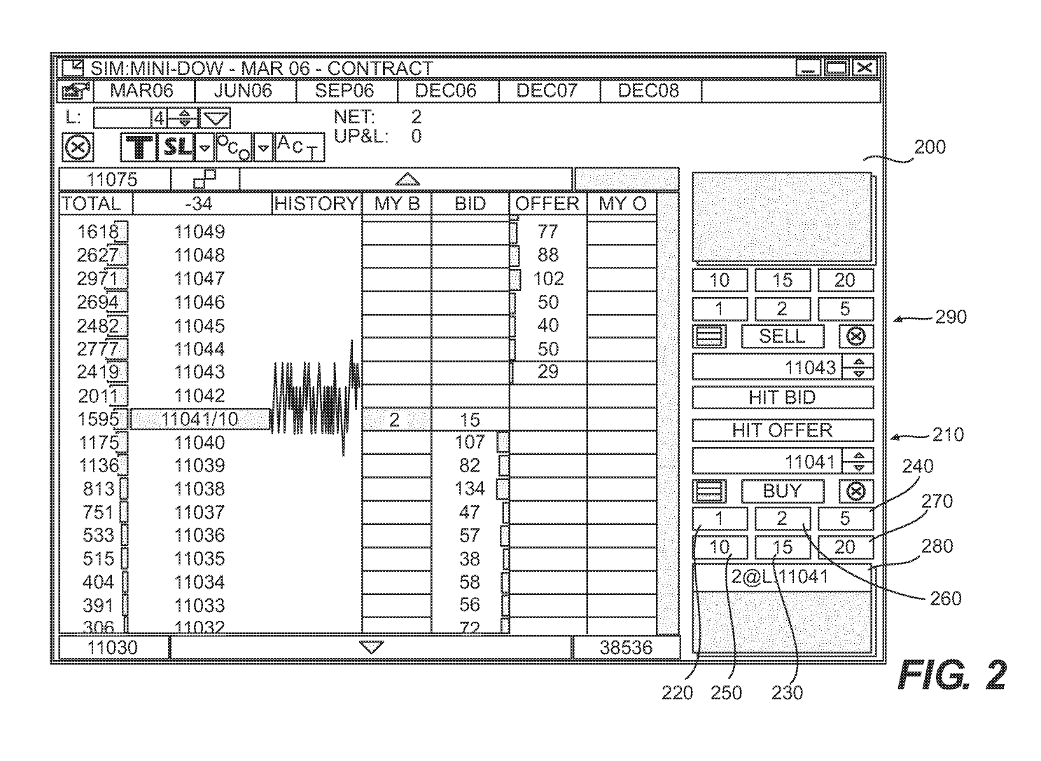

FIG. 2 is illustrative of an embodiment of the present invention wherein the user has previously defined the parameters of the trading software program and specifically, the volume submission parameters, which are displayed in the user input interface 200. In this embodiment, the user has selected from the “Buy” portion 210 of the user input interface 200. A number of predefined lot volume buy orders are displayed, including for 1 contract 220, 2 contracts 230, 5 contracts 240, 10 contracts 250, 15 contracts 260 and 20 contracts 270. The price 280 of the buy order is also displayed within the buy portion 210 of the user input interface 200. In this example, the user has selected a contract buy order of 2 contracts 230 by using one click of the user's mouse or stylus.

It is contemplated that the volume buttons 220, 230, 240, 250, 260, 270 may be selected by the user by a number of different means, depending on the hardware that is being used by the user. For example, the volume buttons 220, 230, 240, 250, 260, 270 may be selected by the user by using a mouse, a stylus, by voice activation, by touch and any number of other means as would be contemplated and appreciated by those of ordinary skill.

Once the user has selected a lot volume, in this case for 2 contracts 230, the trade is initialized and completed as would be understood by those of ordinary skill. Once the trade has been confirmed, the buy portion 210 of the user input interface 200 displays an electronic notification 280 to the user indicating the lot volume and price that the trade was completed. The user can now select another volume button 220, 230, 240, 250, 260, 270 in order to initialize and complete another trade. It is contemplated that the user can also conduct sell orders from with in the user input interface 200 by the same means as described for the buy portion 210 for the volume buttons and displays in the sell portion 290.

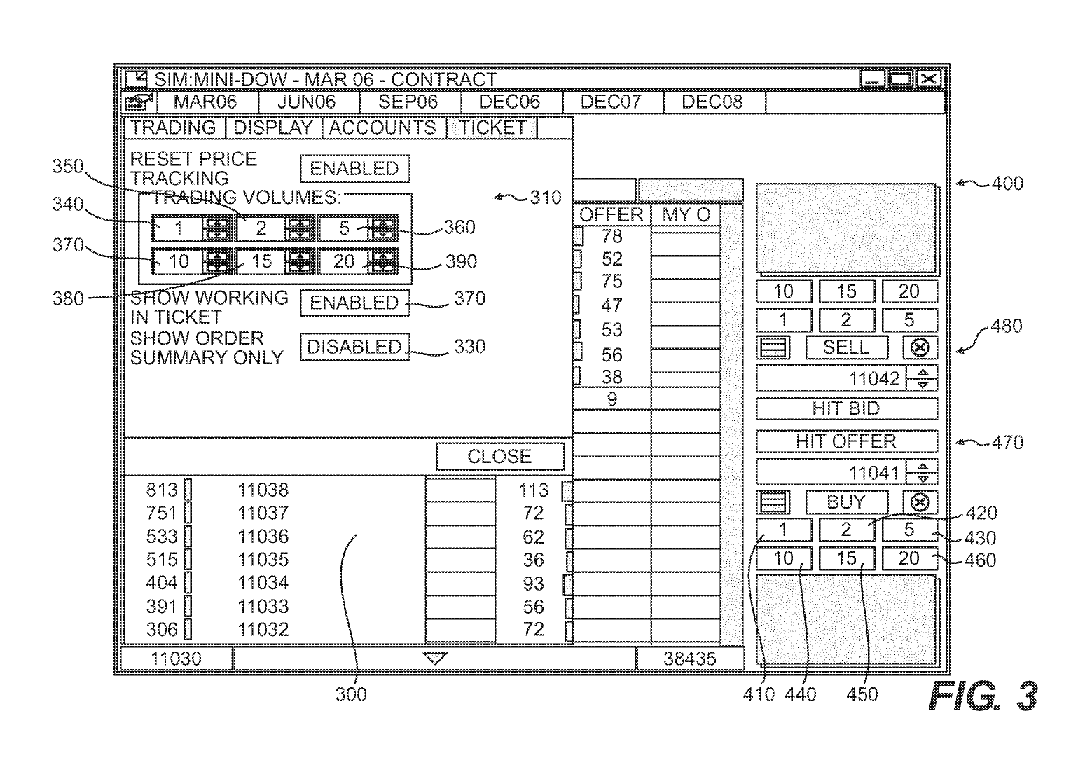

In one embodiment in accordance with the present invention, the user sets the various parameters for the volume buttons as illustrated in FIG. 3. The user opens a dialog box 300 from with in the trading software that corresponds to the options for volume submission trading. The user then has the option of resetting the price tracking, or auto-tracking, 310 to enable automatic re-enabling of price tracking following submission of an order. As explained above, when the auto-tracking feature 310 is enabled, the highlighted price is always the best bid and offer for the market, even when the best bid and offer changes. Moreover, the user can enable or disable the display of working orders 320 within the dialog box 300. In addition, the “Show Order Summary” button 330 allows the user the option of showing the order summary or not showing the order summary.

In accordance with an embodiment of the present invention, the volume buttons that initialize a fixed trade with a single selection can be predetermined by the user. As shown in FIG. 3, the volume button parameters can be set through the Tracking Volume buttons 340, 350, 360, 370, 380, 390. Each of the Tracking Volume buttons can be manually changed by the user to desired volumes. Each of selected Tracking Volume buttons 340, 350, 360, 370, 380, 390 correspond with buttons on the user input interface 400 to the volume buttons 410, 420, 430, 440, 450, 460 of the buy portion 470 that are selected by the user to initialize a trade over the exchange. It is contemplated that the Tracking Volume buttons 340, 350, 360, 370 380, 390 that correspond to the volume buttons of the buy portion 470, will also correspond to the volume buttons located in the sell portion 480 of the user input interface 400. In other variations in accordance with the present invention, however, a separate set of Tracking Volume buttons for the sell portion of the user input interface could be implemented.

It is to be appreciated by those of ordinary skill that embodiments in accordance with the present invention can be achieved using a computer program. For example, the following code is helpful in implementing certain embodiments of the present invention:

```
// The Auto tracking flag is user configurable.
// If enabled the system forces the best bid and best offer to be the
// selected prices.
Set mblnAutoTracking = True
// Routine dedicated to the click of a specific bid button.
Routine OnBidVolume1_Click
    // Reference the button's lot volume.
    Set iBidVolume = BidVolume1.Value
    // Reference the currently selected bid price.
    Set dblBidPrice = MarketGrid.SelectedBidPrice
    // Submit the order.
    SubmitOrder(iBidVolume,dblBidPrice)
End Routine
// Routine dedicated to the click of a specific offer button.
Routine OnOfferVolume3_Click
    // Reference the button's lot volume.
    Set iOfferVolume = OfferVolume3.Value
    // Reference the currently selected offer price.
    Set dblOfferPrice = MarketGrid.SelectedOfferPrice
    // Submit the order.
    SubmitOrder(iOfferVolume,dblOfferPrice)
End Routine
// Submit an order to the exchange based on the current price and
clicked volume.
Routine SubmitOrder(iVolume, dblPrice)
    // Submit the order.
    Define oOrder
    // Populate the order's price and volume.
    oOrder.Price = dblPrice
    oOrder.Volume = iVolume
    // Orders require more prespecified parameters then just price
and volume.
    // These parameters will be set below.
    Populate any additional prespecified order parameters.
    // Submit the order to the exchange.
    oOrder.Submit
End Routine
// Called every time there is an update pending for the market being
traded.
Routine OnMarketUpdate
    // Update the selected prices.
    If mblnAutoTracking = True Then
        Select the best bid to be the current bid price.
        Select the best offer to be the current offer price.
    End If
End Routine
```

The invention has been described with reference to the preferred embodiments. Obviously, modifications and alterations will occur to others upon a reading and understanding of this specification. It is intended that the invention be construed as including all such modifications and alterations insofar as they come within the scope of the appended claims or the equivalents thereof.

1. An improved method for buying and selling over an exchange, comprising:
displaying on an electronic display a price region comprised of a plurality of different prices, a bidding lot region comprised of a plurality of bids for lots at a different prices, and an offering lot region comprised of a plurality of offers for lots at different prices;
updating said regions of said display to reflect real-time trading action of said exchange;
providing a user input interface with the exchange which receives a user input in the form of a command for a desired number of lots, and a communication linkage which registers said input with the exchange;
generating on said electronic display a graphical user lot input window which includes a plurality of predefined selections corresponding to different desired lot volumes;
linking an input to said lot input window to a predefined price; and
implementing a user lot input by a single click on a desired lot volume of said lot input window including order placement.

2. The method of claim 1, wherein said trading action displayed includes an inside market that reflects a best offer and a best bid associated with a respective prices, said graphical user lot input window including separate buy and sell areas each having a plurality of predefined selections corresponding to different desired lot volumes, said linkage having a default predefined price to be a then-existing best offer and best bid.

3. The method of claim 2, wherein the user can select a price as said predefined price instead of said default predefined price.

4. The method of claim 3, wherein said plurality of predefined selections are at least three different desired lot volumes for each of said buy and sell areas.

5. The method of claim 4, wherein said at least six different desired lot volumes are each separately variable by the user.

6. The method of claim 5, wherein said exchange is a commodity exchange.

7. The method of claim 1, wherein a desired price is displayed as a highlighted cell on a price grid consisting of a column of prices and an associated column of available bid quantities and an associated column of available offer quantities.

8. The method of claim 7, wherein said price grid scrolls as an inside market changes, with said inside market moving relative to a center area of said electronic display.

9. The method of claim 8, wherein said inside market is maintained substantially centered on said price grid.

10. A method for trading futures over an exchange, wherein said futures correspond to contracts that have an inside market that reflects a best offer and a best bid for a particular contract, the method comprising:
displaying on an electronic display a price region for each contract, wherein each price region includes a best offer and a best bid associated with a respective prices;
displaying on an electronic display a user input interface separate from the price region for each contract, wherein said user input interface includes two or more predefined selections corresponding to a desired volume that is set to a predefined price; and
receiving one of the predefined selections within the user input interface to initialize a trade for futures.

11. The method of claim 1, wherein the step of implementing a user lot input by a single click on a desired lot volume includes transmitting of the order to the exchange.

12. The method of claim 10, wherein the step for receiving one of the predefined selections is a result of one click user action.

13. A method for buying and selling over an exchange, the method comprising the steps of:
providing an electronically generated user interface having a plurality of selectable order size options, each of the order size options indicative of different order sizes; and
receiving one of the selectable order size options causing an order to be placed electronically with the exchange,
wherein the received selectable order size option is initiated by a single user action that provides an order size;
wherein the providing and receiving steps are performed by a computer.

14. The method of claim 13, wherein the order includes a pre-determined price.

15. The method of claim 13, wherein the single user action is a single click action.

16. An electronic trading tool incorporating computer code that when executed performs the steps of:
providing a user interface having a plurality of selectable order size options, each of the order size options indicative of different order sizes;
receiving one of the selectable order size options causing an order to be placed with the exchange,
wherein the received selectable order size option is initiated by a single user action that provides an order size for fulfillment by the exchange.

17. The electronic trading tool of claim 16, wherein the order includes a pre-determined price.
